(19) United States
(12) Patent Application Publication
(10) Pub. No.: US 2013/0262223 A1
(43) Pub. Date: Oct. 3, 2013

(54) INDOOR NAVIGATION SYSTEM

(71) Applicants: Avishai CATANE, Beit Shemesh (IL); Yehuda FEINBERG, Beit Shemesh (IL); Offir DOR, Beit Shemesh (IL)

(72) Inventors: Avishai CATANE, Beit Shemesh (IL); Yehuda FEINBERG, Beit Shemesh (IL); Offir DOR, Beit Shemesh (IL)

(73) Assignee: INFORMAT INNOVATIVE TECHNOLOGIES LTD., Beit Shemesh (IL)

(21) Appl. No.: 13/431,996

(22) Filed: Mar. 28, 2012

(51) Int. Cl. H04W 4/02; G06Q 30/02; G01S 3/02

(52) U.S. Cl. 705/14.53; 342/463; 705/14.58; 455/457

(57) ABSTRACT

A system for indoor commercial facilities includes a multiplicity of access points to provide connectivity to mobile communications devices in the facility, a tracking module to determine locations for the devices based on connection data provided by the access points as the devices move through the facility, and an I/O module to receive the connectivity data and to transmit a map of a current location to the devices, where the map is relative to a location as determined by the tracking module. A mobile communications device includes a Wi-Fi transceiver to communicate with a multiplicity of Wi-Fi access points arrayed in a facility, where connection data between the transceiver and the access points is suitable for determining a current location of the device in the facility, and a map display to display a map of at least a part of the facility relative to the current location.

### FIELD OF THE INVENTION

The present invention relates to location based navigation systems generally and to indoor, non-GPS based commercial implementations in particular.

### BACKGROUND OF THE INVENTION

Location based services (LBSs) are known in the art. The most widely used LBSs are based on the Global Positioning System (GPS), a space-based navigation system that uses satellites to provide location information anywhere on or near planet Earth. However, GPS based services generally require an unobstructed line of sight to GPS satellites in order to function and so are accordingly not practical for indoor applications.

Indoor based LBSs typically use Wi-Fi based systems to track RFID tags on people or inventory. Aeroscout Inc. and Ekahau Inc., both of the United States, provide a variety of RFID tag based systems that locate, track and manage assets, inventory, staff and visitors in a Wi-Fi environment. Such systems enable wireless tracking and monitoring of people and/or equipment in an indoor environment according to varying levels of resolutions such as, for example, building, floor, department and room. Typical implementations of such systems include warehouse inventory tracking, healthcare and/or security facilities. Each item or person of interest is equipped with a dedicated RFID tag that communicates with a Wi-Fi network. The movement of the items/persons is then tracked within the area of coverage according to the strength and/or triangulation of the signals received from the RFID tags.

### SUMMARY OF THE PRESENT INVENTION

In accordance with a preferred embodiment of the present invention, there is provided a location based system for indoor commercial facilities including a multiplicity of access points to provide connectivity to mobile communications devices in an indoor commercial facility, a tracking module to determine locations for the devices based on connection data provided by the access points as the devices move through the facility, and an I/O module to receive the connectivity data and to transmit a map of a current location to the devices, where the map is relative to a location as determined by the tracking module.

Further, in accordance with a preferred embodiment of the present invention, the system also includes a map database to store reference maps of the indoor commercial facilities, where the map database is accessible by at least one of the tracking module and I/O module.

Still further, in accordance with a preferred embodiment of the present invention, the system also includes a search module to access at least the map database to perform searches of the indoor commercial facilities, where the searches are initiated by users of the devices and where search results are calculated relative to at least the determined locations.

Additionally, in accordance with a preferred embodiment of the present invention, the searches are for at least at least one of a department, person and product in the indoor commercial facilities.

Moreover, in accordance with a preferred embodiment of the present invention, the determined locations include floor levels within the indoor commercial facilities.

Further, in accordance with a preferred embodiment of the present invention, the system also includes at least one promotion database, where the at least one promotion database is at least one of a product database describing products available for sale in the indoor commercial facilities, a pricing database including pricing information for the products, and a user profile database including preference information for users of the system, and a promotion module to provide sales promotions to the users based on at least one of data from the at least one promotion database and the determined locations.

Still further, in accordance with a preferred embodiment of the present invention, the system also includes a history database to store historical data from components of the system, where the preference information is based at least in part on the historical data.

Additionally, in accordance with a preferred embodiment of the present invention, the system also includes a client registrar to register details of users of the system.

Moreover, in accordance with a preferred embodiment of the present invention, the system also includes a client downloader to provide a client application for accessing the system, where the client application is installable on the devices.

There is also provided, in accordance with a preferred embodiment of the present invention, a mobile communications device including a Wi-Fi transceiver to communicate with a multiplicity of Wi-Fi access points arrayed in an indoor commercial facility, where connection data between the transceiver and the access points is suitable for determining a current location of the device in the indoor commercial facility, and a map display to display a map of at least a part of the indoor commercial facility relative to the current location.

Further, in accordance with a preferred embodiment of the present invention, the device also includes a promotion receiver to receive sales promotions to be mapped on the map.

Still further, in accordance with a preferred embodiment of the present invention, the device also includes a search utility to enable a user of the device to search the contents of the indoor commercial utility.

There is also provided, in accordance with a preferred embodiment of the present invention, a method for providing location based services in an indoor commercial facility, the method implemented on a computing device and including receiving connection data from an array of wireless access points in the indoor commercial facility, where the connection data is associated with wireless connections between mobile communications devices and the access points, analyzing the connection data to determine locations for the devices, and transmitting at least a map of a part of the indoor commercial facility to the devices, where the map indicates at least the locations.

Further, in accordance with a preferred embodiment of the present invention, the transmitting comprises transmitting sales promotions, where the sales promotions are based on at least one of the locations and a history of the locations.

Still further, in accordance with a preferred embodiment of the present invention, the method also includes tracking the locations as the devices move through the indoor commercial facility, and storing historical data associated with the tracking, where the historical data is suitable for analyzing traffic patterns within the indoor commercial facility.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a schematic illustration of a novel indoor Wi-Fi based commercial LBS system, constructed and operative in accordance with a preferred embodiment of the present invention;

FIG. 2 is a schematic illustration of a novel commercial LBS server to be implemented within the system of FIG. 1; and

FIG. 3 is a schematic illustration of a novel commercial LBS client application for use with the system of FIG. 1.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Prior art implementations of Wi-Fi based indoor LBSs may generally be focused on non-profit applications with an emphasis on passive tracking of people or inventory throughout an indoor facility. Applicant has realized that the same technical framework may be leveraged to generate a commercially oriented LBS that may be configured to proactively interact with customers to promote sales activity and generally contribute to a more interesting and/or efficient shopping experience.

Applicant has also realized that the dedicated RFID tags used by the prior art may be inappropriate to serve as a platform for a commercial implementation. Prior art implementations may tend to be in restricted environments or secure facilities, such as, for example, hospitals, warehouses and prisons. A significant percentage of persons frequenting such facilities may be employees or detainees that may have their own dedicated RFID tag assigned to them, or visitors that may require a device may be vetted in a relatively thorough and time consuming process. It may be impractical to replicate such a practice for a commercial implementation; the inconvenience of issuing devices to shoppers as they enter a store may outweigh any benefits to be reaped by providing a commercial LBS system.

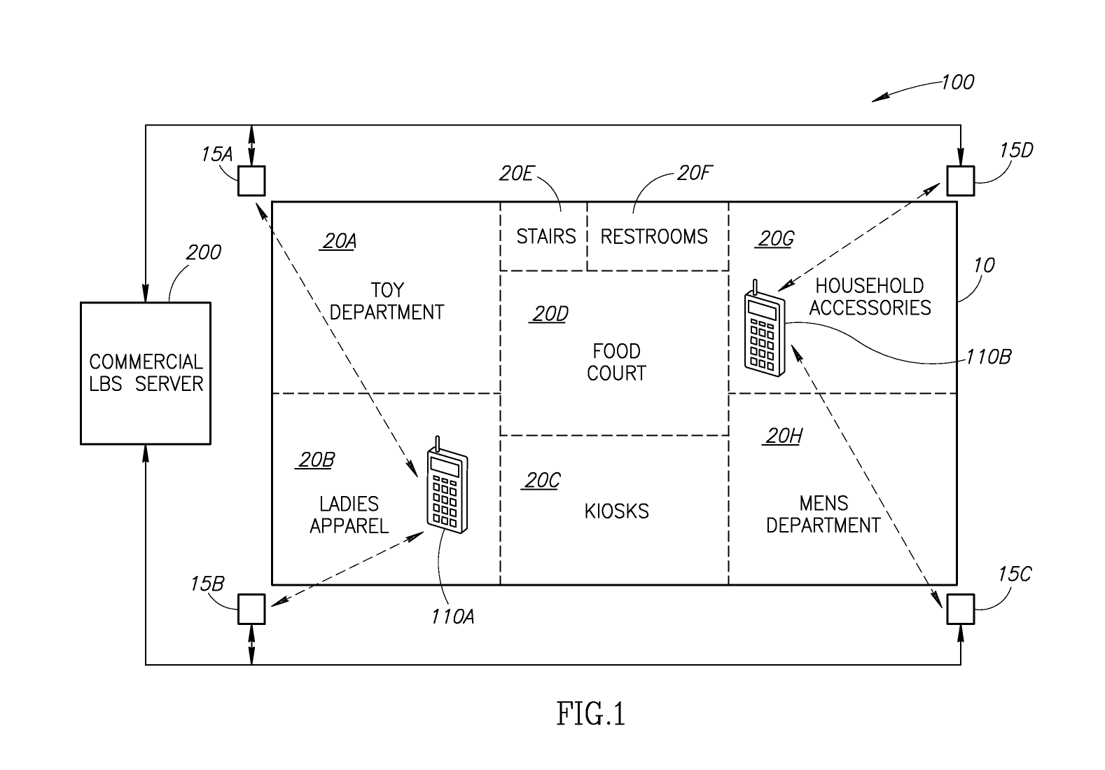

It may therefore be preferable not to issue dedicated RFID devices such as are used in the prior art to commercial users. Instead it may be preferable to use Wi-Fi enabled mobile communications device to interact with an indoor Wi-Fi based commercial LBS application. Reference is now made to FIG. 1, which may illustrate a novel indoor Wi-Fi based commercial LBS system, 100, constructed and operative in accordance with a preferred embodiment of the present invention.

System 100 may comprise an exemplary indoor commercial facility 10, Wi-Fi access points 15 and commercial LBS server 200. Facility 10 may comprise departments 20 which may represent different departments, rooms and/or areas of an exemplary department store. Access points 15 may communicate with server 200 and may be deployed to generally provide Wi-Fi coverage throughout facility 10. It will be appreciated that the depiction of direct connections between access points 15 and server 200 may be exemplary; the present invention may also include any other suitable method of connection including, for example, wireless and/or Internet based indirect connections.

Mobile communication devices 110 may connect to server 200 via one or more access points 15. Device 110 may be, for example, a programmable smartphone with Wi-Fi connectivity. It will be appreciated that the present invention may include support for any mobile programmable device with Wi-Fi connectivity, such as, for example, a smartphone, PDA, tablet computer or notebook computer. Server 200 may use connection data received from access points 15 to determine a location for a given device 110 within facility 10.

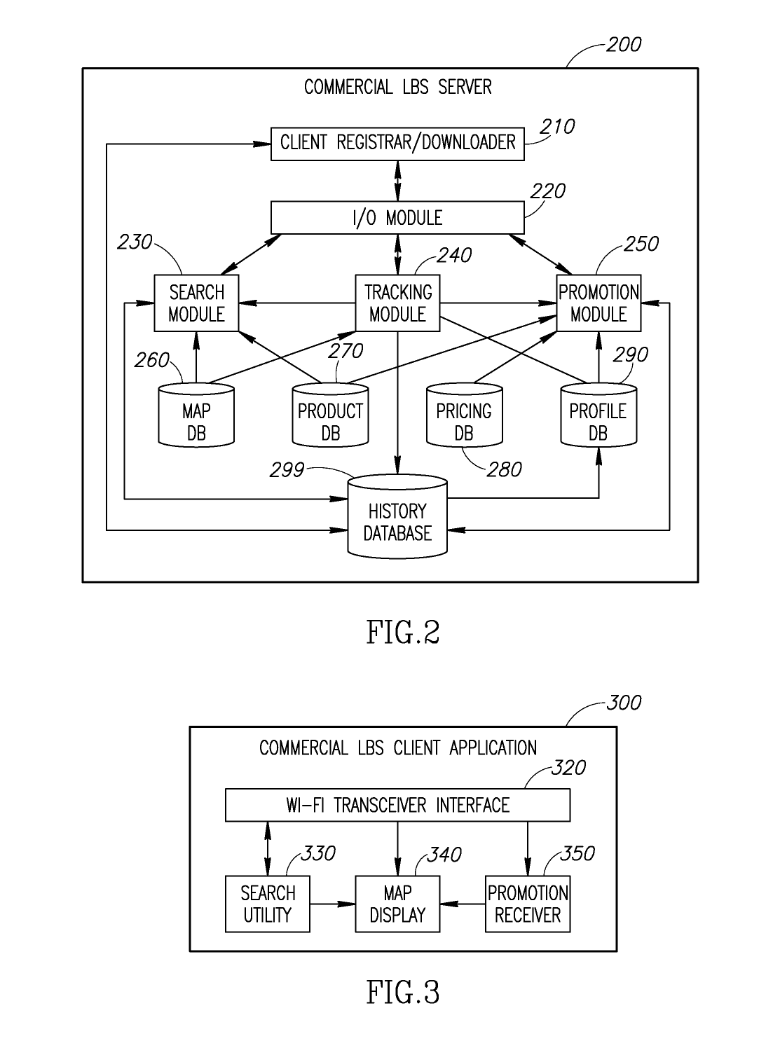

Reference is now made to FIG. 2 which illustrates a novel Wi-Fi based commercial LBS server, constructed and operative in accordance with a preferred embodiment of the present invention. It will be appreciated that the depiction of server 200 as a single entity may be exemplary; the present invention may also include embodiments wherein the functionality of server 200 may be provided by a configuration of multiple physical servers.

Server 200 may comprise client registrar/downloader 210, I/O module 220, search module 230, tracking module 240 and promotion module 250. Server 200 may also comprise map database 260, product database 270, pricing database 280, profile database 290 and history database 299.

I/O module 220 may be used to communicate with devices 110 (FIG. 1) via access points 15. In accordance with a preferred embodiment of the present invention, devices 110 may require the installation of a dedicated client application to access the functionality of server 200. To facilitate such a download, customers entering facility 10 may be instructed to activate built-in Wi-Fi functionality on their devices on access a specific URL to request a client application download.

Requests to download the client application may be received via I/O module 220 and forwarded to client downloader 210. Client registrar/downloader 210 may be configured to register details regarding device 110 and/or its associated user, for example, the name of the user and/or the phone number associated with device 110. Client registrar/downloader 210 may also comprise the means necessary for facilitating a download of the client application to the requesting device 110. Client registrar/downloader 210 may update history database 299 with the details of the registration and/or client download.

It will be appreciated that the information required (if at all) for registration may be configurable. It will further be appreciated that user/device registration and client application download may not be interdependent procedures. For example, in accordance with a preferred alternative embodiment of the present invention, device 110 may use a web browser to access the functionality of server 200 without a dedicated application. Similarly, the present invention may also be configured to provide support for users to download the client application without providing any registration details to client registrar/downloader 210.

As devices 110 with active Wi-Fi connections move throughout facility 10, I/O module 220 may receive connection data from access points 15 in communication with devices 110. I/O module 220 may forward the connection data to Tracking module 240. Tracking module 240 may comprise commercially available software, such as that available from Ekahau Inc., for establishing a location based on WI-Fi signals. Such software may enable tracking module 240 to determine the location of a device 110 based on its associated connection data received from multiple access points 15. Tracking module 240 may use such software to determine a location for a given device 110 based on the known locations of access points 15 relative to one or more maps of facility 10, stored in map database 260. Tracking module 240 may update history database 299 on a periodic basis regarding the movements of devices 110.

Reference is now made to FIG. 3 which illustrates an exemplary commercial LBS client application 300, constructed and operative in accordance with a preferred embodiment of the present invention. Application 300 may be downloaded by client downloader/registrar as described hereinabove, and installed on device 110. Alternatively, application 300 may also be downloaded by a client from an Internet web server prior to entering facility 10.

Application 300 may comprise Wi-Fi Transceiver interface 320 which may interface between application 300 and the built-in Wi-Fi functionality in device 110. Application 300 may also comprise map display 340 which may receive input from tracking module 240 on server 200 to display a current map of the vicinity of device 110. In accordance with preferred embodiment of the present invention, a “you are here” indication may be displayed as well to indicate the location of device 110 as determined by tracking module 240. It will be appreciated that there may be multiple floor levels in facility 10. Accordingly, map display 340 may be configured to indicate the floor level for each displayed map.

Application 300 may also comprise search utility 330. Search utility 330 may provide the user of device 110 with an interactive interface to search for products and/or specific departments 20 within facility 10. Search requests entered via search utility 330 may be forwarded via interface 320 and I/O module 220 to search module 230 on server 300. Search module may lookup the details of the search request in map database 260, product database 270, and or both.

For example, a user may submit a request for the location of a toy truck. Search module 230 may lookup the corresponding product in product database 270. Product database 270 may indicate that the toy truck may be found at a particular set of coordinates within toy department 20A. Search module 230 may then lookup the indicated coordinates in map database 260 to identify the relevant map. Search module 230 may also look up any maps that may be needed to navigate the requesting user from the present location of device 110 (as determined by tracking module 240) to the desired location in toy department 20A. Search module 230 may then return the looked up data to application 300 via I/O module 220 and interface 320. The data may then be forwarded to map display 240 to present one or more maps to the user that may illustrate how to navigate from the current location to the location of the toy truck.

It will be appreciated that a user may just need to find a given department 20. For example, search utility 330 may be used to request directions to toy department 20A. In such a case, search module 230 may search only in map database 260, without using product database 270.

Application 300 may also comprise promotion receiver 350. Applicant has realized that knowing the location of a user (as per the location of an associated device 110) may be leveraged as an opportunity to send the user sales promotions relevant for that particular location. For example tracking module 240 may determine that device 110 is located in toy department 20A. This information may be forwarded to promotion module 250, which may access product database 270 to identify products located in that location that may be offered for sale to the user of device 110. The identified product information may then be sent to device 110 and received by promotion receiver 250 from interface 320. The product information may, for example, include a picture and/or sales/marketing details that promotion receiver 350 may display as a “popup” on device 110. Promotion receiver 250 may also forward the details to map display 340 to integrate the location of the product(s) on the map display of facility 10.

Promotion module 350 may also access pricing database 280 to offer price reductions for the promoted products. The price detail may also be forwarded to promotion receiver 350. It will be appreciated that promotion module 350 may employ other means for forwarding promotions to device 110. For example, the registration process may include a phone number for device 110 or an email for its associated user. Promotion module 250 may comprise means for sending a promotional SMS to device 110 or an email to its associated email address.

In accordance with a preferred embodiment of the present invention, server 300 may comprise profile database 290 which may store profiles for registered users. The profiles may be based on details provided during registration and/or historical data from history database 299 such as, for example, past purchases and/or the locations visited by the users and how long they stayed in given locations. For example, if a registered user had visited facility 10 three times in the past and each time tracking module 240 tracked the user through toy department 20A repeatedly, a preference for toys may be entered in the user's associated profile even if no toy purchases were made.

User profiles may also be updated in accordance with historical search data stored in history database 299. For example, if a user performs repeated searches for toy trucks, a preference for toy trucks may be entered in the user's associated profile regardless of whether or not the user ever bought a toy truck or even visited toy department 20A.

Accordingly it will be appreciated that system 100 may leverage the ubiquitous presence of Wi-Fi enabled devices 110 to provide a commercially oriented indoor navigation system that may not require additional investment in terms of both time and financial resources to outfit each customer of a facility 10 with a dedicated RFID tag to provide location based services.

It will be appreciated that in addition to finding departments and products, search utility 330 and search module 230 may also be configured to facilitate the location of appropriate sales help or the user's friends on a map of facility 10.

It will also be appreciated that the historical tracking data stored in history database 299 may be used to provide customized reporting and diagnostic utilities for the operator of facility 10. For example, the data may be used to generate sales tracking reports, as well as analyses of customer traffic patterns as they move throughout facility 10.

It will further be appreciated that the present invention may also comprise sales and marketing tools to generate recommended actions based on the data in history database 299. For example, a facility layout utility may be provided to recommend changes in the layout of facility 10 based on customer traffic and/or purchasing patterns. An anomaly detection utility may also be provided to detect inconsistencies between traffic and sales patterns. For example, traffic patterns (as measured by frequency of visits and/or units of time for given visits) may indicate significant interest in a given product, whereas sales for the product may be relatively low. In such a case, the anomaly detection utility may flag the product as requiring further investigation, or even suggest a price reduction to stimulate sales.

Unless specifically stated otherwise, as apparent from the preceding discussions, it is appreciated that, throughout the specification, discussions utilizing terms such as “processing,” “computing,” “calculating,” “determining,” or the like, refer to the action and/or processes of a computer, computing system, or similar electronic computing device that manipulates and/or transforms data represented as physical, such as electronic, quantities within the computing system's registers and/or memories into other data similarly represented as physical quantities within the computing system's memories, registers or other such information storage, transmission or display devices.

Embodiments of the present invention may include apparatus for performing the operations herein. This apparatus may be specially constructed for the desired purposes, or it may comprise a general-purpose computer selectively activated or reconfigured by a computer program stored in the computer. Such a computer program may be stored in a computer readable storage medium, such as, but not limited to, any type of disk, including floppy disks, optical disks, magnetic-optical disks, read-only memories (ROMs), compact disc read-only memories (CD-ROMs), random access memories (RAMs), electrically programmable read-only memories (EPROMs), electrically erasable and programmable read only memories (EEPROMs), magnetic or optical cards, Flash memory, or any other type of media suitable for storing electronic instructions and capable of being coupled to a computer system bus.

The processes and displays presented herein are not inherently related to any particular computer or other apparatus. Various general-purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the invention as described herein.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A location based system for indoor commercial facilities comprising:
a multiplicity of access points to provide connectivity to mobile communications devices in an indoor commercial facility;
a tracking module to determine locations for said devices based on connection data provided by said access points as said devices move through said facility; and
an I/O module to receive said connectivity data and to transmit a map of a current location to said devices, wherein said map is relative to a location as determined by said tracking module.

2. The system according to claim 1 and also comprising a map database to store reference maps of said indoor commercial facilities, wherein said map database is accessible by at least one of said tracking module and I/O module.

3. The system according to claim 2 and also comprising a search module to access at least said map database to perform searches of said indoor commercial facilities, wherein said searches are initiated by users of said devices and wherein search results are calculated relative to at least said determined locations.

4. The system according to claim 3 and wherein said searches are for at least at least one of a department, person and product in said indoor commercial facilities.

5. The system according to claim 1 and wherein said determined locations include floor levels within said indoor commercial facilities.

6. The system according to claim 1 and also comprising:
at least one promotion database, wherein said at least one promotion database is at least one of a product database describing products available for sale in said indoor commercial facilities, a pricing database including pricing information for said products, and a user profile database including preference information for users of said system; and
a promotion module to provide sales promotions to said users based on at least one of data from said at least one promotion database and said determined locations.

7. The system according to claim 6 and also comprising a history database to store historical data from components of said system, wherein said preference information is based at least in part on said historical data.

8. The system according to claim 1 and also comprising a client registrar to register details of users of said system.

9. The system according to claim 1 and also comprising a client downloader to provide a client application for accessing said system, wherein said client application is installable on said devices.

10. A mobile communications device comprising:
a Wi-Fi transceiver to communicate with a multiplicity of Wi-Fi access points arrayed in an indoor commercial facility, wherein connection data between said transceiver and said access points is suitable for determining a current location of said device in said indoor commercial facility; and
a map display to display a map of at least a part of said indoor commercial facility relative to said current location.

11. The device according to claim 10 and also comprising a promotion receiver to receive sales promotions to be mapped on said map.

12. The device according to claim 10 and also comprising a search utility to enable a user of said device to search the contents of said indoor commercial utility.

13. A method for providing location based services in an indoor commercial facility, the method implemented on a computing device and comprising:
receiving connection data from an array of wireless access points in said indoor commercial facility, wherein said connection data is associated with wireless connections between mobile communications devices and said access points;
analyzing said connection data to determine locations for said devices; and
transmitting at least a map of a part of said indoor commercial facility to said devices, wherein said map indicates at least said locations.

14. The method according to claim 13 and wherein said transmitting comprises transmitting sales promotions, wherein said sales promotions are based on at least one of said locations and a history of said locations.

15. The method according to 13 and also comprising:
tracking said locations as said devices move through said indoor commercial facility; and
storing historical data associated with said tracking, wherein said historical data is suitable for analyzing traffic patterns within said indoor commercial facility.
